(19) United States
(12) Patent Application Publication
(10) Pub. No.: US 2025/0079778 A1
(43) Pub. Date: Mar. 6, 2025

(54) MALE POWER CONNECTOR, FEMALE POWER CONNECTOR AND POWER CONNECTOR SET

(71) Applicant: BIZLINK INTERNATIONAL CORP., New Taipei City (TW)

(72) Inventors: Xiangwu WANG, New Taipei City (TW); Chubei ZHANG, New Taipei City (TW)

(21) Appl. No.: 18/951,693

(22) Filed: Nov. 19, 2024

Related U.S. Application Data
(63) Continuation-in-part of application No. 17/858,064, filed on Jul. 5, 2022.

(30) Foreign Application Priority Data
Jul. 6, 2021 (CN) 202110761128.X
Nov. 15, 2021 (CN) 202122792114.2

(51) Int. Cl. H01R 24/30; H01R 13/04; H01R 13/11; H01R 13/506; H01R 24/22; H01R 105/00

(52) U.S. Cl. CPC H01R 24/30; H01R 13/04; H01R 13/113; H01R 13/506; H01R 24/22; H01R 2105/00

(57) ABSTRACT

A male power connector includes a first terminal, a second terminal, a ground terminal and a housing. The housing has a first passage, a second passage and a ground passage. The first passage accommodates the first terminal and has a first opening on an endmost front surface of the housing. The second passage accommodates the second terminal and has a second opening on the endmost front surface. The ground passage accommodates the ground terminal and has a ground opening on the endmost front surface. The ground opening has a main portion accommodating the ground terminal, two lateral extending portions and two notch portions. The lateral extending portions extend outwardly from opposite sides of the main portion. The notch portions respectively extend from a corresponding one of the lateral extending portions in a direction away from the first opening and the second opening.

### RELATED APPLICATIONS

This application is a Continuation-in-part of U.S. application Ser. No. 17/858,064, filed on Jul. 5, 2022, which claims priority of Chinese Application Serial Number 202110761128.X, filed on Jul. 6, 2021, and Chinese Application Serial Number 202122792114.2, filed on Nov. 15, 2021, the entirety of which is incorporated by reference herein in their entireties.

### BACKGROUND

### Technical Field

The present disclosure relates to power connector sets, each of which has a male power connector and a female power connector connected with each other. More particularly, the present disclosure relates to high current connectors.

### Description of Related Art

In the US patent US2023/0011560A1, a male connector and a female connector are disclosed. The female connector is configured to be connected with the male connector. The male connector has a first terminal hole, a second terminal hole and a third terminal hole on its front end surface. The first terminal hole is configured to allow a first terminal seat of the female connector with a conductive terminal set to insert therein. The second terminal hole is configured to allow a second terminal seat of the female connector with a conductive terminal set to insert therein. The third terminal hole is configured to allow a third terminal seat of the female connector with a conductive terminal set to insert therein. However, when the housing of the male connector having the first terminal hole, the second terminal hole and the third terminal hole is manufactured by injection molding, there is a high chance that the dimensional tolerances of the housing exceed a standard range.

### SUMMARY

A technical aspect of the present disclosure is to provide a male power connector, which can achieve a high accuracy on the control of dimensional tolerances of the male housing.

According to an embodiment of the present disclosure, a male power connector includes a first terminal, a second terminal, a ground terminal and a housing. The housing has a first passage, a second passage and a ground passage. The first passage accommodates the first terminal and has a first opening on an endmost front surface of the housing. The second passage accommodates the second terminal and has a second opening on the endmost front surface. The ground passage accommodates the ground terminal and has a ground opening on the endmost front surface. The ground opening has a main portion accommodating the ground terminal, two lateral extending portions and two notch portions. The lateral extending portions extend outwardly from opposite sides of the main portion. The notch portions respectively extend from a corresponding one of the lateral extending portions in a direction away from the first opening and the second opening.

In one or more embodiments of the present disclosure, the endmost front surface has an inner edge defines the first opening, the second opening and the ground opening. The inner edge has two curved portions respectively defining one of the notch portions.

In one or more embodiments of the present disclosure, the first opening, the second opening, the ground opening, the first passage, the second passage and the ground passage are communicated with each other.

In one or more embodiments of the present disclosure, the housing defines an insertion direction. The first passage, the second passage and the ground passage respectively extend along the insertion direction.

In one or more embodiments of the present disclosure, the housing includes an outer wall, a first isolation wall, a second isolation wall, a first protrusion and a second protrusion. The outer wall defines the insertion direction. The first isolation wall is connected with the outer wall and at least partially isolates between the first passage and the ground passage. The second isolation wall is connected with the outer wall and at least partially isolates between the second passage and the ground passage. The first protrusion is connected with the first isolation wall and extends along the insertion direction. The first protrusion faces to and aligns with a corresponding one of the notch portions. The second protrusion is connected with the second isolation wall and extends along the insertion direction. The second protrusion faces to and aligns with another corresponding one of the notch portions.

In one or more embodiments of the present disclosure, the housing further includes a third isolation. The third isolation wall is connected with the outer wall and at least partially isolates between the first passage and the second passage. The third isolation wall is at least partially located between and spaced apart from the first isolation wall and the second isolation wall. The third isolation wall and the outer wall define the ground passage therebetween.

A technical aspect of the present disclosure is to provide a female power connector, which can achieve a proper connection with a male power connector having a first protrusion and a second protrusion as an indicating feature for a user to notice the presence of the notch portions.

According to an embodiment of the present disclosure, a female power connector includes a housing. The housing includes a body, an outer wall, a first terminal seat, a second terminal seat, a third terminal seat and two structural plates. The outer wall is connected with the body. The first terminal seat is connected with the body and located inside the outer wall. The first terminal seat is disposed with a first conductive terminal set thereon. The second terminal seat is connected with the body and located inside the outer wall. The second terminal seat is disposed with a second conductive terminal set thereon. The third terminal seat is connected with the body and located inside the outer wall. The third terminal seat is disposed with a third conductive terminal set thereon. The structural plates are connected to opposite sides of the third terminal seat. Each of the structural plates is hook-shaped and has a hook-opening respectively facing toward the first terminal seat and the second terminal seat.

In one or more embodiments of the present disclosure, the outer wall defines an insertion direction. The hook-openings respectively extend along the insertion direction.

In one or more embodiments of the present disclosure, the first terminal seat and the second terminal seat are arranged along a first direction. The third terminal seat and a middle point of the first terminal seat and the second terminal seat are arranged along a second direction. The first direction, the second direction and the insertion direction are perpendicular with each other.

In one or more embodiments of the present disclosure, the structural plates are spaced apart from the outer wall.

In one or more embodiments of the present disclosure, the first terminal seat, the second terminal seat and the third terminal seat are respectively spaced apart from the outer wall.

A technical aspect of the present disclosure is to provide a power connector set, which can achieve a high accuracy on the control of dimensional tolerances of the male housing.

According to an embodiment of the present disclosure, a power connector set includes a male power connector and a female power connector. The male power connector includes a first terminal, a second terminal, a ground terminal and a male housing. The male housing has a first passage, a second passage and a ground passage. The first passage accommodates the first terminal and has a first opening on an endmost front surface of the male housing. The second passage accommodates the second terminal and has a second opening on the endmost front surface. The ground passage accommodates the ground terminal and has a ground opening on the endmost front surface. The ground opening has a main portion accommodating the ground terminal, two lateral extending portions and two notch portions. The lateral extending portions extend outwardly from opposite sides of the main portion. The notch portions respectively extend from a corresponding one of the lateral extending portions in a direction away from the first opening and the second opening. The female power connector is configured to be connected with the male power connecter. The female power connector includes a female housing. The female housing includes a body, a female outer wall, a first terminal seat, a second terminal seat, a third terminal seat and two structural plates. The female outer wall is connected with the body. The first terminal seat is connected with the body and located inside the female outer wall. The first terminal seat is disposed with a first conductive terminal set thereon. The second terminal seat is connected with the body and located inside the female outer wall. The second terminal seat is disposed with a second conductive terminal set thereon. The third terminal seat is connected with the body and located inside the female outer wall. The third terminal seat is disposed with a third conductive terminal set thereon. The structural plates are connected to opposite sides of the third terminal seat. When the male power connector and the female power connector are connected, the male housing at least partially inserts into the female outer wall, the first terminal seat enters into the first passage through the first opening such that the first conductive terminal set connects with the first terminal, the second terminal seat enters into the second passage through the second opening such that the second conductive terminal set connects with the second terminal, the third terminal seat enters into the ground passage through the main portion such that the third conductive terminal set connects with the ground terminal, the structural plates enter into the ground passage through the lateral extending portions, at least a part of the notch portions remain vacant.

In one or more embodiments of the present disclosure, the endmost front surface has an inner edge defining the first opening, the second opening and the ground opening. The inner edge has two curved portions respectively defining one of the notch portions.

In one or more embodiments of the present disclosure, the first opening, the second opening, the ground opening, the first passage, the second passage and the ground passage are communicated with each other.

In one or more embodiments of the present disclosure, the male power connector and the female power connector are connected along an insertion direction. The first passage, the second passage and the ground passage respectively extend along the insertion direction.

In one or more embodiments of the present disclosure, the male housing includes a male outer wall, a first isolation wall, a second isolation wall and a third isolation wall. The male outer wall defines the insertion direction. The first isolation wall is connected with the male outer wall and at least partially isolates between the first passage and the ground passage. The second isolation wall is connected with the male outer wall and at least partially isolates between the second passage and the ground passage. The third isolation wall is connected with the male outer wall and at least partially isolates between the first passage and the second passage. The third isolation wall is at least partially located between and spaced apart from the first isolation wall and the second isolation wall. The third isolation wall and the male outer wall define the ground passage therebetween. When the male power connector and the female power connector are connected, the male outer wall inserts into the female outer wall.

In one or more embodiments of the present disclosure, the first terminal seat and the second terminal seat are arranged along a first direction. The third terminal seat and a middle point of the first terminal seat and the second terminal seat are arranged along a second direction. The first direction, the second direction and the insertion direction are perpendicular with each other.

In one or more embodiments of the present disclosure, the structural plates are spaced apart from the female outer wall.

In one or more embodiments of the present disclosure, the first terminal seat, the second terminal seat and the third terminal seat are respectively spaced apart from the female outer wall.

The above-mentioned embodiments of the present disclosure have at least the following advantages:

(1) With the presence of the notch portions on the male housing, when the male housing is manufactured by injection molding, the deviation of the shape of the male housing from the mold is minimized. In other words, the degree of deformation of the male housing after the process of injection molding is reduced. Thus, there can be a high accuracy on the control of dimensional tolerances of the male housing.

(2) The presence of the first protrusion and the second protrusion corresponding to the notch portions can be an indicating feature for a user to notice the presence of the notch portions.

(3) Since the first protrusion and the second protrusion of the male housing can be respectively accommodated in a corresponding one of the hook-openings of the female housing, a proper connection between the female power connector and the male power connector having the first protrusion and the second protrusion can be achieved.

### BRIEF DESCRIPTION OF THE DRAWINGS

The disclosure can be more fully understood by reading the following detailed description of the embodiments, with reference made to the accompanying drawings as follows:

FIG. 1 is a schematic view of a power connector set according to a first embodiment of the present disclosure, in which the male power connector and the female power connector are separated from each other;

FIG. 2 is a schematic view of the power connector set of FIG. 1, in which the male housing and the female housing are partially omitted;

FIG. 3 is a sectional view of the power connector set of FIG. 1, in which the male power connector and the female power connector are connected with each other;

FIG. 4 is a schematic view of a power connector set according to a second embodiment of the present disclosure, in which the male power connector and the female power connector are separated from each other; and

FIG. 5 is a sectional view of the power connector set of FIG. 4, in which the male power connector and the female power connector are connected with each other.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

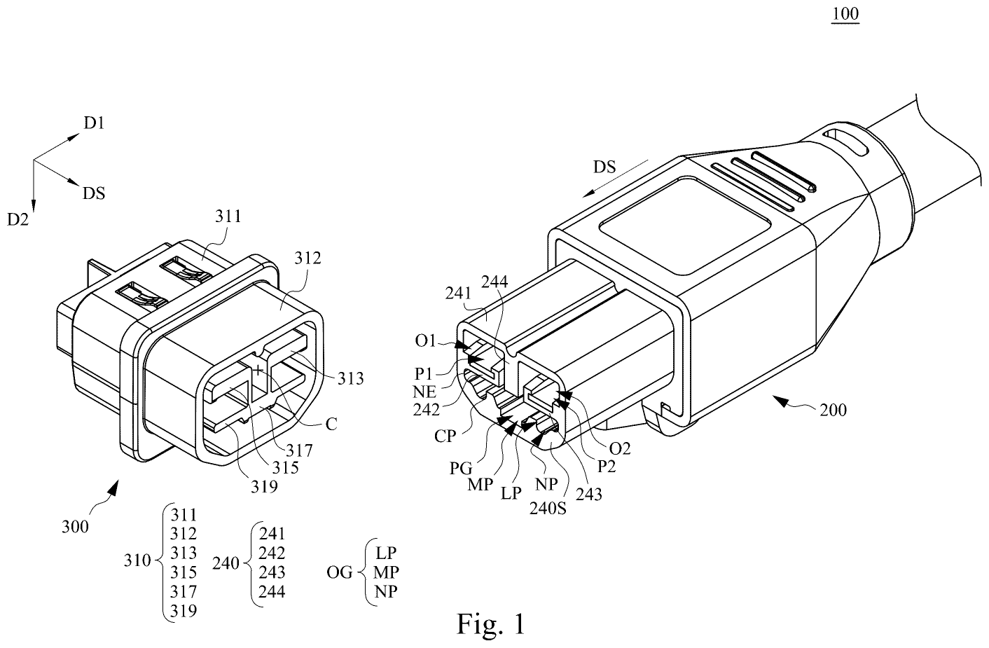

FIGS. 1-5 are drawn according to the actual scale. For the sake of concise description in this specification, the scales of the elements are not listed one by one. However, the scale and position of each element should be regarded as part of the scope of this specification.

Furthermore, if the description in this specification is insufficient to explain the detailed design of the elements and makes it uneasy to implement, please take the electrical connector disclosed in the U.S. patent Ser. No. 18/641,361 as a reference.

As shown in FIGS. 1-5, a power connector set 100 is provided in the present disclosure. Moreover, for example, the power connector set 100 is utilized for electrical connection of high current.

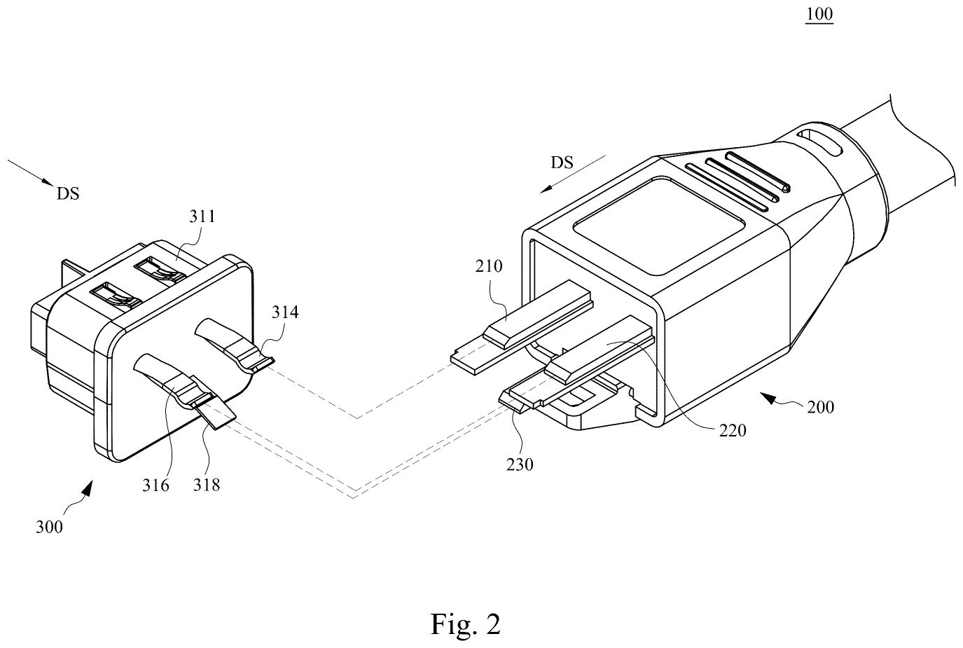

FIG. 1 is a schematic view of a power connector set 100 according to a first embodiment of the present disclosure, in which the male power connector 200 and the female power connector 300 are separated from each other. FIG. 2 is a schematic view of the power connector set 100 of FIG. 1, in which the male housing 240 and the female housing 310 are partially omitted. In this embodiment, as shown in FIGS. 1-2, a power connector set 100 includes a male power connector 200 and a female power connector 300. The male power connector 200 includes a first terminal 210, a second terminal 220, a ground terminal 230 and a male housing 240. The male housing 240 has a first passage P1, a second passage P2 and a ground passage PG. The first passage P1 has a first opening O1 on an endmost front surface 240S of the male housing 240. The second passage P2 has a second opening O2 on the endmost front surface 240S. The ground passage PG has a ground opening OG on the endmost front surface 240S. The ground opening OG has a main portion MP accommodating the ground terminal 230, two lateral extending portions LP and two notch portions NP. The lateral extending portions LP extend outwardly from opposite sides of the main portion MP. The notch portions NP respectively extend from a corresponding one of the lateral extending portions LP in a direction away from the first opening O1 and the second opening O2. On the other hand, the female power connector 300 includes a female housing 310. The female housing 310 includes a body 311, a female outer wall 312, a first terminal seat 313, a second terminal seat 315, a third terminal seat 317 and two structural plates 319.

Furthermore, for the male power connector 200 as shown in FIGS. 1-2, the first passage P1 accommodates the first terminal 210. The second passage P2 accommodates the second terminal 220. The ground passage PG accommodates the ground terminal 230. On the other hand, the female outer wall 312 is connected with the body 311. The first terminal seat 313 is connected with the body 311 and located inside the female outer wall 312. The first terminal seat 313 is disposed with a first conductive terminal set 314 thereon. The second terminal seat 315 is connected with the body 311 and located inside the female outer wall 312. The second terminal seat 315 is disposed with a second conductive terminal set 316 thereon. The third terminal seat 317 is connected with the body 311 and located inside the female outer wall 312. The third terminal seat 317 is disposed with a third conductive terminal set 318 thereon. The structural plates 319 are connected to opposite sides of the third terminal seat 317.

Furthermore, as shown in FIG. 1, the endmost front surface 240S has an inner edge NE. The inner edge NE defines the first opening O1, the second opening O2 and the ground opening OG. The inner edge NE has two curved portions CP respectively defining one of the notch portions NP.

Moreover, as shown in FIG. 1, the first opening O1, the second opening O2, the ground opening OG, the first passage P1, the second passage P2 and the ground passage PG are communicated with each other.

In addition, as shown in FIG. 1, the male housing 240 includes a male outer wall 241, a first isolation wall 242, a second isolation wall 243 and a third isolation wall 244. The male outer wall 241 defines an insertion direction DS. The first isolation wall 242 is connected with the male outer wall 241 and at least partially isolates between the first passage P1 and the ground passage PG. The second isolation wall 243 is connected with the male outer wall 241 and at least partially isolates between the second passage P2 and the ground passage PG. The third isolation wall 244 is connected with the male outer wall 241 and at least partially isolates between the first passage P1 and the second passage P2. The third isolation wall 244 is at least partially located between and spaced apart from the first isolation wall 242 and the second isolation wall 243. The third isolation wall 244 and the male outer wall 241 define the ground passage PG therebetween. When the male power connector 200 and the female power connector 300 are connected, the male outer wall 241 of the male power connector 200 inserts into the female outer wall 312 of the female power connector 300.

Moreover, as shown in FIG. 1, the first terminal seat 313 and the second terminal seat 315 are arranged along a first direction D1. The third terminal seat 317 and a middle point C of the first terminal seat 313 and the second terminal seat 315 are arranged along a second direction D2. The first direction D1, the second direction D2 and the insertion direction DS are perpendicular with each other.

In addition, as shown in FIG. 1, the first terminal seat 313, the second terminal seat 315, the third terminal seat 317 and the structural plates 319 are respectively spaced apart from the female outer wall 312.

As shown in FIG. 2, the electrical connections between the first conductive terminal set 314 and the first terminal 210, the second conductive terminal set 316 and the second terminal 220, the third conductive terminal set 318 and the ground terminal 230 are respectively presented by hidden lines connected therebetween. In fact, the male power connector 200 and the female power connector 300 are connected with each other along the insertion direction DS which is a straight direction. Furthermore, the first passage P1, the second passage P2 and the ground passage PG respectively extend along the insertion direction DS.

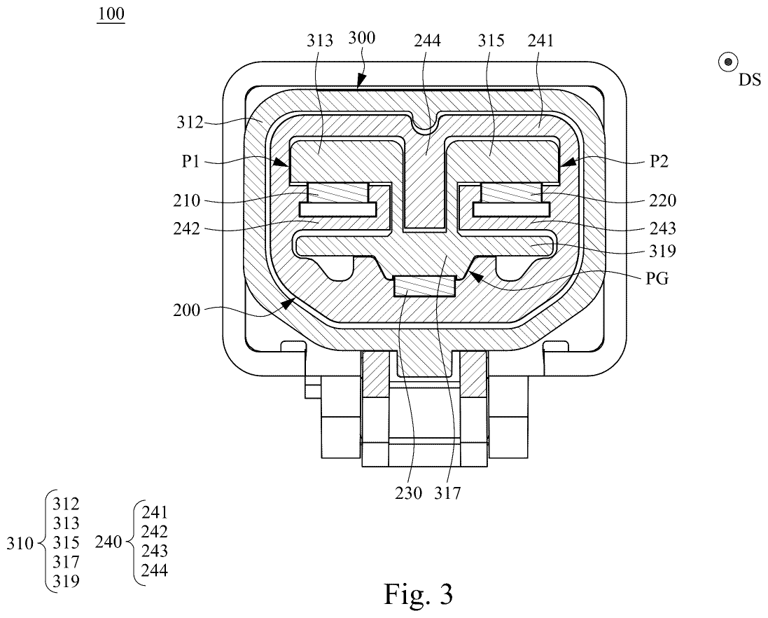

FIG. 3 is a sectional view of the power connector set 100 of FIG. 1, in which the male power connector 200 and the female power connector 300 are connected with each other. As shown in FIG. 3, when the male power connector 200 and the female power connector 300 are connected, the male housing 240 at least partially inserts into the female outer wall 312, the first terminal seat 313 of the female power connector 300 enters into the first passage P1 of the male power connector 200 through the first opening O1 such that the first conductive terminal set 314 electrically connects with the first terminal 210, the second terminal seat 315 of the female power connector 300 enters into the second passage P2 of the male power connector 200 through the second opening O2 such that the second conductive terminal set 316 electrically connects with the second terminal 220, the third terminal seat 317 of the female power connector 300 enters into the ground passage PG of the male power connector 200 through the main portion MP of the ground opening OG such that the third conductive terminal set 318 electrically connects with the ground terminal 230, the structural plates 319 enter into the ground passage PG through the lateral extending portions LP. It is worth to note that, the whole notch portions NP of the male power connector 200 remain vacant as depicted in FIG. 3. This means there is substantially none of any portion of the female power connector 300 is spatially located in the notch portions NP of the male power connector 200 after the male power connector 200 and the female power connector 300 are connected with each other. However, it should be mentioned that the notch does not need to be completely vacant. As long as at least a part of the notch portions remains vacant or empty, it can help to mitigate the reduction in yield caused by material size changes during the molding process to some extent.

With the presence of the notch portions NP on the male housing 240, when the male housing 240 is manufactured by injection molding, the deviation of the shape of the male housing 240 from the mold is minimized. In other words, the degree of deformation of the male housing 240 after the process of injection molding is reduced. Thus, there can be a high accuracy on the control of dimensional tolerances of the male housing 240.

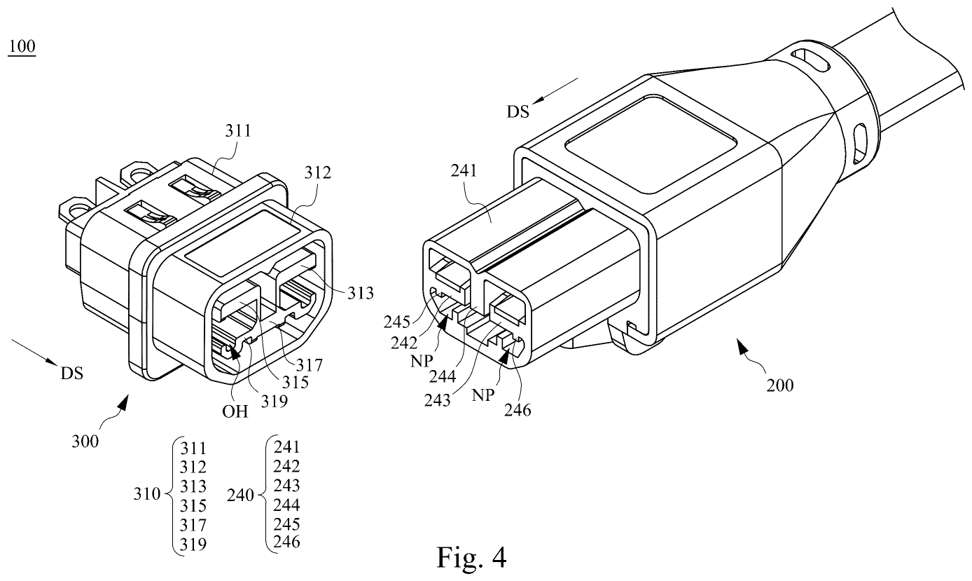

FIG. 4 is a schematic view of a power connector set 100 according to a second embodiment of the present disclosure, in which the male power connector 200 and the female power connector 300 are separated from each other. In this embodiment, as shown in FIG. 4, the male housing 240 further includes a first protrusion 245 and a second protrusion 246. The first protrusion 245 is connected with the first isolation wall 242 and extends along the insertion direction DS. The first protrusion 245 faces to and aligns with a corresponding one of the notch portions NP. The second protrusion 246 is connected with the second isolation wall 243 and extends along the insertion direction DS. The second protrusion 246 faces to and aligns with another corresponding one of the notch portions NP. The presence of the first protrusion 245 and the second protrusion 246 corresponding to the notch portions NP can be an indicating feature for a user to notice the presence of the notch portions NP.

Correspondingly, as shown in FIG. 4, each of the structural plates 319 of the female power connector 300 is hook-shaped and has a hook-opening OH respectively facing toward the first terminal seat 313 and the second terminal seat 315. Moreover, the hook-openings OH respectively extend along the insertion direction DS.

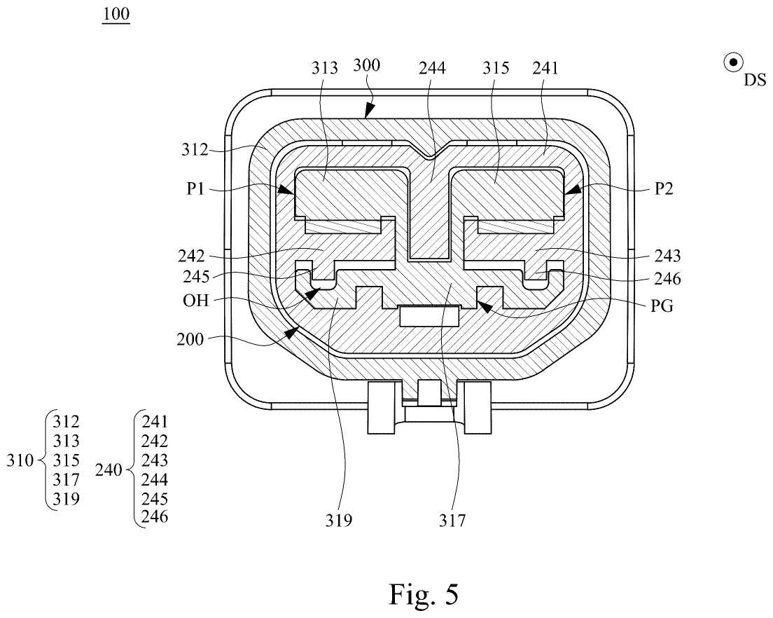

FIG. 5 is a sectional view of the power connector set 100 of FIG. 4, in which the male power connector 200 and the female power connector 300 are connected with each other. As shown in FIG. 5, when the male power connector 200 and the female power connector 300 are connected, the first protrusion 245 and the second protrusion 246 of the male housing 240 are respectively accommodated in a corresponding one of the hook-openings OH, such that a proper connection between the female power connector 300 and the male power connector 200 having the first protrusion 245 and the second protrusion 246 can be achieved.

In conclusion, the aforementioned embodiments of the present disclosure have at least the following advantages:

(1) With the presence of the notch portions on the male housing, when the male housing is manufactured by injection molding, the deviation of the shape of the male housing from the mold is minimized. In other words, the degree of deformation of the male housing after the process of injection molding is reduced. Thus, there can be a high accuracy on the control of dimensional tolerances of the male housing.

(2) The presence of the first protrusion and the second protrusion corresponding to the notch portions can be an indicating feature for a user to notice the presence of the notch portions.

(3) Since the first protrusion and the second protrusion of the male housing can be respectively accommodated in a corresponding one of the hook-openings of the female housing, a proper connection between the female power connector and the male power connector having the first protrusion and the second protrusion can be achieved.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A male power connector, comprising:
a first terminal;
a second terminal;
a ground terminal; and
a housing having:
a first passage accommodating the first terminal and having a first opening on an endmost front surface of the housing;
a second passage accommodating the second terminal and having a second opening on the endmost front surface; and
a ground passage accommodating the ground terminal and having a ground opening on the endmost front surface, the ground opening having a main portion accommodating the ground terminal, two lateral extending portions and two notch portions, the lateral extending portions extending outwardly from opposite sides of the main portion, the notch portions respectively extending from a corresponding one of the lateral extending portions in a direction away from the first opening and the second opening.

2. The male power connector of claim 1, wherein the endmost front surface has an inner edge defining the first opening, the second opening and the ground opening, the inner edge has two curved portions respectively defining one of the notch portions.

3. The male power connector of claim 1, wherein the first opening, the second opening, the ground opening, the first passage, the second passage and the ground passage are communicated with each other.

4. The male power connector of claim 1, wherein the housing defines an insertion direction, the first passage, the second passage and the ground passage respectively extend along the insertion direction.

5. The male power connector of claim 4, wherein the housing comprises:
an outer wall defining the insertion direction;
a first isolation wall connected with the outer wall and at least partially isolating between the first passage and the ground passage;
a second isolation wall connected with the outer wall and at least partially isolating between the second passage and the ground passage;
a first protrusion connected with the first isolation wall and extending along the insertion direction, the first protrusion facing to and aligning with a corresponding one of the notch portions; and
a second protrusion connected with the second isolation wall and extending along the insertion direction, the second protrusion facing to and aligning with another corresponding one of the notch portions.

6. The male power connector of claim 5, wherein the housing further comprises:
a third isolation wall connected with the outer wall and at least partially isolating between the first passage and the second passage, the third isolation wall is at least partially located between and spaced apart from the first isolation wall and the second isolation wall, the third isolation wall and the outer wall define the ground passage therebetween.

7. A female power connector, comprising:
a housing, comprising:
a body;
an outer wall connected with the body;
a first terminal seat connected with the body and located inside the outer wall, the first terminal seat being disposed with a first conductive terminal set thereon;
a second terminal seat connected with the body and located inside the outer wall, the second terminal seat being disposed with a second conductive terminal set thereon;
a third terminal seat connected with the body and located inside the outer wall, the third terminal seat being disposed with a third conductive terminal set thereon; and
two structural plates connected to opposite sides of the third terminal seat, each of the structural plates being hook-shaped and having a hook-opening respectively facing toward the first terminal seat and the second terminal seat.

8. The female power connector of claim 7, wherein the outer wall defines an insertion direction, the hook-openings respectively extend along the insertion direction.

9. The female power connector of claim 8, wherein the first terminal seat and the second terminal seat are arranged along a first direction, the third terminal seat and a middle point of the first terminal seat and the second terminal seat are arranged along a second direction, the first direction, the second direction and the insertion direction are perpendicular with each other.

10. The female power connector of claim 7, wherein the structural plates are spaced apart from the outer wall.

11. The female power connector of claim 7, wherein the first terminal seat, the second terminal seat and the third terminal seat are respectively spaced apart from the outer wall.

12. A power connector set, comprising:
a male power connector comprising:
a first terminal;
a second terminal;
a ground terminal; and
a male housing having:
a first passage accommodating the first terminal and having a first opening on an endmost front surface of the male housing;
a second passage accommodating the second terminal and having a second opening on the endmost front surface; and
a ground passage accommodating the ground terminal and having a ground opening on the endmost front surface, the ground opening having a main portion accommodating the ground terminal, two lateral extending portions and two notch portions, the lateral extending portions extending outwardly from opposite sides of the main portion, the notch portions respectively extending from a corresponding one of the lateral extending portions in a direction away from the first opening and the second opening; and
a female power connector configured to be connected with the male power connecter, the female power connector comprising:
a female housing, comprising:
a body;
a female outer wall connected with the body;
a first terminal seat connected with the body and located inside the female outer wall, the first terminal seat being disposed with a first conductive terminal set thereon;
a second terminal seat connected with the body and located inside the female outer wall, the second terminal seat being disposed with a second conductive terminal set thereon;
a third terminal seat connected with the body and located inside the female outer wall, the third terminal seat being disposed with a third conductive terminal set thereon; and
two structural plates connected to opposite sides of the third terminal seat,
wherein when the male power connector and the female power connector are connected, the male housing at least partially inserts into the female outer wall, the first terminal seat enters into the first passage through the first opening such that the first conductive terminal set connects with the first terminal, the second terminal seat enters into the second passage through the second opening such that the second conductive terminal set connects with the second terminal, the third terminal seat enters into the ground passage through the main portion such that the third conductive terminal set connects with the ground terminal, the structural plates enter into the ground passage through the lateral extending portions, at least a part of the notch portions remain vacant.

13. The power connector set of claim 12, wherein the endmost front surface has an inner edge defining the first opening, the second opening and the ground opening, the inner edge has two curved portions respectively defining one of the notch portions.

14. The power connector set of claim 12, wherein the first opening, the second opening, the ground opening, the first passage, the second passage and the ground passage are communicated with each other.

15. The power connector set of claim 12, wherein the male power connector and the female power connector are connected along an insertion direction, the first passage, the second passage and the ground passage respectively extend along the insertion direction.

16. The power connector set of claim 15, wherein the male housing comprises:
a male outer wall defining the insertion direction;
a first isolation wall connected with the male outer wall and at least partially isolating between the first passage and the ground passage;
a second isolation wall connected with the male outer wall and at least partially isolating between the second passage and the ground passage; and
a third isolation wall connected with the male outer wall and at least partially isolating between the first passage and the second passage, the third isolation wall is at least partially located between and spaced apart from the first isolation wall and the second isolation wall, the third isolation wall and the male outer wall define the ground passage therebetween,
wherein when the male power connector and the female power connector are connected, the male outer wall inserts into the female outer wall.

17. The power connector set of claim 12, wherein the first terminal seat and the second terminal seat are arranged along a first direction, the third terminal seat and a middle point of the first terminal seat and the second terminal seat are arranged along a second direction, the first direction, the second direction and the insertion direction are perpendicular with each other.

18. The power connector set of claim 12, wherein the structural plates are spaced apart from the female outer wall.

19. The power connector set of claim 12, wherein the first terminal seat, the second terminal seat and the third terminal seat are respectively spaced apart from the female outer wall.
